(19) United States
(12) Patent Application Publication
(10) Pub. No.: US 2007/0046560 A1
(43) Pub. Date: Mar. 1, 2007

(54) Interleaved text display

(75) Inventors: Charles F. Neugebauer, Los Altos, CA (US); Michael W. Patterson, Portland, OR (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 11/216,689

(22) Filed: Aug. 30, 2005

(51) Int. Cl. G09G 5/00

(52) U.S. Cl. 345/1.1

(57) ABSTRACT

A flexible electronic display device containing a plurality of fields for displaying information is disclosed. The electronic display device comprises an active area having at least one field comprising a series of interleaved characters that can be selectively activated such that different messages are readable depending upon which characters are activated. The active area can comprise additional fields.

### CROSS-REFERENCE TO RELATED APPLICATIONS

This application is related to U.S. patent application Ser. No. 11/155,125, filed on Jun. 16, 2005 entitled “Low Power Wireless Communication System And Protocol” and U.S. patent application Ser. No. 11/156,193, filed on Jun. 16, 2005 entitled “Pseudo Noise Coded Communication Systems”. The disclosures of these applications are hereby incorporated herein by reference in their entireties.

### FIELD

The present application relates to user changeable text displays and more particularly relates to very low cost electronic display labels that can have textual messages changed in the field.

### BACKGROUND

Selling products to consumers has changed dramatically. Typical stores today are large, with many items for sale. Some retailers, for example supermarkets and other types of “big box” retailers, can have thousands of items for sale at any one time. All of these items are generally available on the sales floor for selection by consumers. Most stores place products on shelves. These shelves have lips with shelf labels affixed thereto that contain information regarding price, special offers, unit pricing and other information. Traditionally, these paper shelf labels are printed with this information and affixed to the shelf by an employee of the retailer. An exemplary shelf label 10 like those currently in use can be seen in FIG. 1.

Whenever the price for the product displayed on the shelf label changes, an employee will remove the old paper label and replace it with a new one. Likewise, when a special offer for a particular product is made, an employee may replace the existing paper label or place a special paper label adjacent to the old label, with the additional label indicating what the special price for that item is. An exemplary shelf label 20 showing an example of an “Extra Value” or “Temporary Price Reduction” offer is shown in FIG. 2.

In addition to special offers available to any customer, many retailers have loyalty programs and clubs that provide special benefits to members. Oftentimes, members of such programs receive lower prices than non-members. As in the case of “Extra Value” sales like those shown in FIG. 2, special club values are typically communicated via a special paper shelf label. An exemplary “Club Price” shelf label 30 can be seen in FIG. 3. On the shelf label 30 shown in FIG. 3, the price of a product has been reduced, which is communicated via the shelf label 30. Of course, there are many different types of special offers. For example, a retailer may offer a “2 for $1” sale or the like, often called an “N-for” in the industry. In “N-for” special offers, the consumer buys N items for the stated total price. Thus, in a three for $1 sale, the consumer would receive three items for $1. The term “N-for” herein is used as an example to show any multiple item sale. An exemplary “N-for” shelf label 40 is seen in FIG. 4. Another type of special offer is the “buy one, get one free” offer. An exemplary “buy one, get one free” shelf label 50 can be seen in FIG. 5. Such offers are commonly referred to as “BOGOs” in the industry.

Each price change and/or special offer requires an employee to affix the paper label to the shelf. This labor represents a significant expenditure in many retail businesses. Electronic shelf labels (ESLs) have been proposed as a solution but have met with only limited success due to their high cost. In addition, prior ESLs are not well suited for sales environments that will have differing messages displayed thereon. To be useful, ESLs must be able to easily display different types of messages to consumers. For example, they must be able to convey various different types of special offers, including the “Extra Value”, “Club Price”, “two for $1” and “buy one, get one free” type offers.

The ability to easily display multiple promotional messages is needed for ESLs. However, traditional ESLs have used display layouts in which only limited types of information can be displayed at any one time, for example only the price and a short alphanumeric field with a few characters. In order to handle relatively long promotional text messages (e.g. “buy one, get one free”), prior ESLs typically break the message into multiple frames which are displayed sequentially on the electronic display. For example, “buy one, get one free” is typically spread over three frames, first “buy one”, then “get one” and lastly “free”, each frame being shown for a few seconds. The regular price, perhaps the club price, the date of the sale and the unit price (e.g. price per ounce) are often legally mandated and require additional frames on a typical current ESL. Given these constraints, it is not uncommon to see conventional ESLs that require as many as seven sequential frames to display the required content. As a result, the consumer is required to watch the ESL for an extended period of time to receive all of the information regarding the product pricing. Furthermore, if the consumer starts watching in the middle of a promotion message cycle, they will likely have to watch for the remainder of the cycle and the full cycle again to comprehend the promotion sequence. Thus a consumer may need on average need to watch ten frames of an ESL display's sequence to receive the promotion information which may take thirty seconds or more. Such a long observation period requires a significant alteration of consumer shopping behavior and has been a major source of consumer complaints in conventional ESL installations.

One approach to improving the display of information on an ESL is to use a higher function display such as a dot matrix display which allows the simultaneous display of many characters, numbers and/or graphics. While technically possible, the cost and power requirements of dot matrix display technology (typically at least an order of magnitude higher than segmented displays) precludes their use in all but a few very price insensitive ESL markets. Display cost is roughly proportional to the number of uniquely addressable segments or pixels of the display; minimizing the number of display segments is an important method of cost reduction in electronic information displays.

The lack of a low cost and consumer friendly method of quickly and concisely displaying information on ESLs has been a major factor limiting their commercial success.

There is therefore a need for an ESL having a display that is inexpensive but has a highly flexible display arrangement that can quickly communicate pricing information to consumers.

### SUMMARY

An improved ESL is disclosed that is inexpensive to build, can be updated, and contains an arrangement of display information that allows many different messages to be displayed without many sequential frames. These messages can be updated in the field through the use of a communication system, for example low data rate wireless (e.g., radiofrequency) communication systems like those described in U.S. patent application Ser. No. 11/155,125, filed on Jun. 16, 2005 entitled “Low Power Wireless Communication System And Protocol” and U.S. patent application Ser. No. 11/156,193, filed on Jun. 16, 2005 entitled “Pseudo Noise Coded Communication Systems”.

In the various preferred embodiments, the characters of a first message are alternated or interleaved with the characters of other messages in character sets. The characters are selectively activated. All characters comprising the messages embedded in the character sets are preferably on the same line in the active area of a segmented LCD display. Activating the letters associated with the first message and deactivating the letters associated with the other messages results in display of the first message. Similarly, activating only the letters associated with a second message and deactivating those associated with the other messages encoded into the character set results in display of the second message. This character selectivity provides legibility combined with eliminating the need to display multiple frames of images. This allows a consumer to quickly read the shelf label, which as discussed was a significant drawback to prior ESLs.

In one embodiment, the display system can comprise a housing containing an electronic display device having an active area. The active area comprises a first interleaved character set region comprising a plurality of selectively activated characters. The selectively activated characters are interleaved such that a plurality of different messages can be displayed depending upon activation states of the plurality of selectively activated characters.

In an embodiment, the plurality of selectively activated characters of the first interleaved character set region comprises LSIAMVIETTWHARSU.

In an embodiment, the display device can also comprise an interleaved segmented alphanumeric region comprising a plurality of segmented numerical characters, a “/” a “.” and at least one symbol indicative of a currency denomination. The display first interleaved character set region in combination with the interleaved segmented alphanumeric region can display “THRU xx/xx”, where each “x” comprises an integer formed by selectively activating segments of the plurality of segmented numerical characters.

In another embodiment, the first interleaved character set region in combination with the interleaved segmented alphanumeric region can display “WAS xx.xx”, where each “x” comprises an integer formed by selectively activating segments of the plurality of segmented numerical characters.

In another embodiment, the display first interleaved character set region in combination with the interleaved segmented alphanumeric region can display “SAVE axx.xxz”, where each “x” comprises an integer formed by selectively activating segments of the plurality of segmented numerical characters and wherein “a” and “z” comprise currency denomination symbols. Usually, only one of said at least one currency denomination symbols will be activated at a time.

In another embodiment, the display system further comprises a second interleaved character set region comprised of a plurality of selectively activated characters and at least one segmented numerical display. The selectively activated characters are interleaved such that a plurality of different messages can be displayed depending upon activation states of the plurality of selectively activated characters. In an embodiment, the plurality of selectively activated characters of the second interleaved character set region comprise BOUNY.

In an embodiment, the first interleaved character set region is located above the second interleaved character set region, thereby allowing said first interleaved character set region and said second interleaved character set region to display words that can be read as a message.

In an embodiment, the first interleaved character set region can have its characters selectively activated to display “SAVE” and the second interleaved character set region can have its characters selectively activated to display “ON” while its at least one segmented numerical displays a number, thereby forming a message stating “SAVE ON x”, where x is an integer comprised of at least one digit.

In an embodiment, the display system comprises a pricing display region comprising a plurality of display segments. Each of the plurality of display segments comprises segments that can be selectively activated to display an alphanumeric character.

In an embodiment, the pricing display region can have segments of the plurality of display segments selectively activated to display a numeric price.

In an embodiment, the pricing display region can have segments of the plurality of display segments selectively activated to display a word. One such word is “FREE”.

In an embodiment, the active area further comprises a first special message region comprising a plurality of selectively activated words. One such word that can be selectively activated is the word “get”.

In an embodiment, the active area con can comprise a special character region comprising selectively activated characters and at least one segmented numerical character. One of the at least one of said selectively activated characters that can be located in the special character region is a symbol indicative of a currency denomination. One of the selectively activated characters located in the special character region is a “/”. One of the at least one segmented numerical character is comprised of segments that can be selectively activated to display a number.

In an embodiment, the first special message region is located to the left of the special character region and the special character region is located to the left of the pricing display region.

In an embodiment, the active area further comprises a second interleaved character set region comprising a plurality of selectively activated characters and at least one segmented numerical display. The selectively activated characters are interleaved such that a plurality of different messages can be displayed depending upon the activation states of the plurality of selectively activated characters.

In an embodiment, the plurality of selectively activated characters of the second interleaved character set region comprises BOUNY.

In an embodiment, the second interleaved character set region, the first special message region, the special character region and the pricing display region can have their characters and segments selectively activated to form messages stating “BUY x get y FREE”, where “x” and “y” are integers. The “x” and “y” can be the same value integers or different valued integers depending on the desired promotion.

In an embodiment, the active area of the electronic display device comprises an LCD device having said first interleaved character set region fabricated thereon. The LCD device is disposed in a package

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE DRAWINGS

FIG. 1 shows an exemplary prior art shelf label.

FIG. 2 shows an exemplary prior art shelf label showing that the price of an item has been reduced.

FIG. 3 shows an exemplary prior art shelf label showing that members of a special club receive a special offer for an item.

FIG. 4 shows an exemplary prior art shelf label showing an “N-for” offer.

FIG. 5 shows an exemplary prior art shelf label showing a “buy one, get one free” offer.

FIG. 6 an exemplary prior art fourteen-segment display that can be used to display alphabetical and numerical characters.

FIG. 7 shows an exemplary embodiment of an LCD display using an arrangement of LCD segments allowing for display of various pricing and special offers.

FIG. 8 shows an example of an ESL having a variable display area showing a regular price for an item.

FIG. 9 shows an example of an ESL having a variable display showing an Extra Value offer.

FIG. 10 shows an example of an ESL having a variable display showing a Club price.

FIG. 11 shows an example of an ESL having a variable display showing an “N-for” offer.

FIG. 12 shows an example of an ESL having a variable display showing a “buy one, get one free” offer.

FIG. 13 shows an embodiment of an ESL mounted on a lip of shelf.

It should be noted that the figures are not drawn to scale and that elements of similar structures or functions are generally represented by like reference numerals for illustrative purposes throughout the figures. It also should be noted that the figures are only intended to facilitate the description of the preferred embodiments.

### DETAILED DESCRIPTION OF THE DRAWINGS

Each of the additional features and teachings disclosed below may be utilized separately or in conjunction with other features and teachings to provide an improved text display. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

In particular, the present teachings can be applied to many applications in addition to ESLs that similarly require low cost display of information. Examples of such applications include but are not limited to calculators, watches, personal digital assistants, remote controls, portable music players, portable communication devices, cell phones, medical equipment, physiological monitoring devices, temperature meters, test equipment, sensor displays, electronic equipment, consumer electronics, toys, cash registers, promotional displays, and generally all applications where low cost displays are needed.

Information display techniques are disclosed herein for use with segmented electronic displays. A character set having a plurality of characters that can be selectively activated is fabricated onto a display. In the presently preferred embodiments, liquid crystal displays (“LCDs”) are used because of their low cost and low power consumption. In addition or in the alternative, the present teachings can be implemented with any display technology, including but not limited to light emitting diodes, zero power displays, mechanical displays, printed displays, emissive and non emissive displays, electrophoretic displays, vacuum flourescent displays, field emmission displays, electroluminescent displays, cathode ray tubes, micromachine displays and generally all controllable or modifiable display technologies.

An example of how messages can be interleaved within a character set is provided on the first line below. As is seen, the character set contains a series of characters (in this example, letters). Immediately below, one can see that this particular character set has two messages interleaved therein that can be displayed by selectively activating the characters so that they are displayed:

NCOLNUMBE MPBREIRC EP R I C E
C L U B P R I C E
N O N M E M B E R P R I C E

As is seen in this example, by fabricating the characters “NCOLNUMBE MPBREIRC EP R I C E” onto an active area of a display, a first message (“CLUB PRICE”) and a second message (“NONMEMBER PRICE”) can be displayed, depending upon which character set is selectively activated.

In the presently preferred embodiments, the various characters comprising a variable display are fabricated onto an active area of an LCD display and are activated using conventional driver and addressing circuitry. This allows many messages to be displayed with a low cost ESL. The character sets are permanently lithographically etched into the LCD (typical of low cost segmented LCDs) and the characters within a set are preferably electrically connected together so as to appear as a single pixel (or dot or segment) to the LCD drive electronics. By combining multiple characters into a single electrical display segment, the electrical LCD drive system is considerably simplified over conventional approaches using segmented alphanumeric characters or dot matrix displays.

There are many advantages provided by using interleaved text. As an example of the usefulness of using interleaved text, an alternative method, wherein messages are fabricated adjacent one another in the same line (i.e., not interleaved), will now be discussed. Thus, a line of characters arranged as follows can display two messages:

| | | |
|---|---|---|
| LIMITSAVE | $2 | [All Available Characters] |
| LIMIT | 2 | [First Message] |
| SAVE | $2 | [Second Message] |

Using this method, the characters that are not activated result in too much white space existing in between displayed words (e.g. between LIMIT and the digit 2), thereby rendering the message difficult to read.

As will now be demonstrated, interleaving these same messages improves readability:

| | | |
|---|---|---|
| LSIAMVIET | $2 | [All Available Characters] |
| L I M I T | 2 | [First Message] |
| S A V E | $2 | [Second Message] |

As can be seen, interleaving characters eliminates most of the white space, which dramatically increases the legibility of the message.

There are other approaches for ESLs that do not utilize interleaving characters. However, these other approaches have disadvantages that render them inappropriate for ESL applications where cost and power consumption are of paramount concern.

In one alternate approach, dot matrix characters are used that allow any combination of characters to be displayed without the need to interleave characters. However, the circuitry required for addressing such a dot matrix display would be much more complicated than the circuitry needed to address the characters. For example, in the example discussed above utilizing the character arrangement “NCOLNUMBE MPBREIRC EP R I C E”, the driver and addressing circuitry must be able to address and activate either of the two sets of characters independently, effectively reducing the content to the equivalent of two pixels or dots on a conventional dot matrix display. By contrast, in a dot matrix display, there are typically forty or more dots for each character. Thus, a line of dot matrix characters can require driver and addressing circuitry for hundreds of dots. Such driver and addressing circuitry has higher cost and consumes more power than the interleaved character embodiments described herein. High cost and power consumption is undesirable in ESL applications. Low cost is important, since a large store might deploy thousands of ESLs. Thus, the increased costs associated with a dot matrix system would by multiplied by the thousands of ESLs required by the retailer. This increased cost could render an ESL system economically impractical. In addition, typical ESLs are run on batteries that are expected to last for several years. Increasing power consumption will reduce service life and thus also render ESL systems economically undesirable.

Another alternative method for displaying text messages on segmented displays that reduces cost when compared to dot matrix displays is to use segmented alphanumeric displays, usually with characters comprising eleven, fourteen or sixteen segments. An exemplary fourteen-segment display 60 is shown in FIG. 6. While segmented alphanumeric characters give more flexibility than lithographically defined words such as “ON” and “BUY” (which are each a single segment or pixel), segmented alphanumeric displays require significantly more segments and therefore require a more costly driver integrated circuit. Increasing the segment count also causes voltages to go up and contrast to go down in conventional LCD technology with consequently undesirable effects on cost and readability, respectively. Moreover, most readers prefer the clean lithographic font of characters when compared to choppy segmented alphanumeric displays, even when the segmented alphanumeric displays are larger. However, as will be seen, there is a place for segmented alphanumeric characters in an ESL having interleaved characters. For example, segmented alphanumeric characters can be useful for displaying prices.

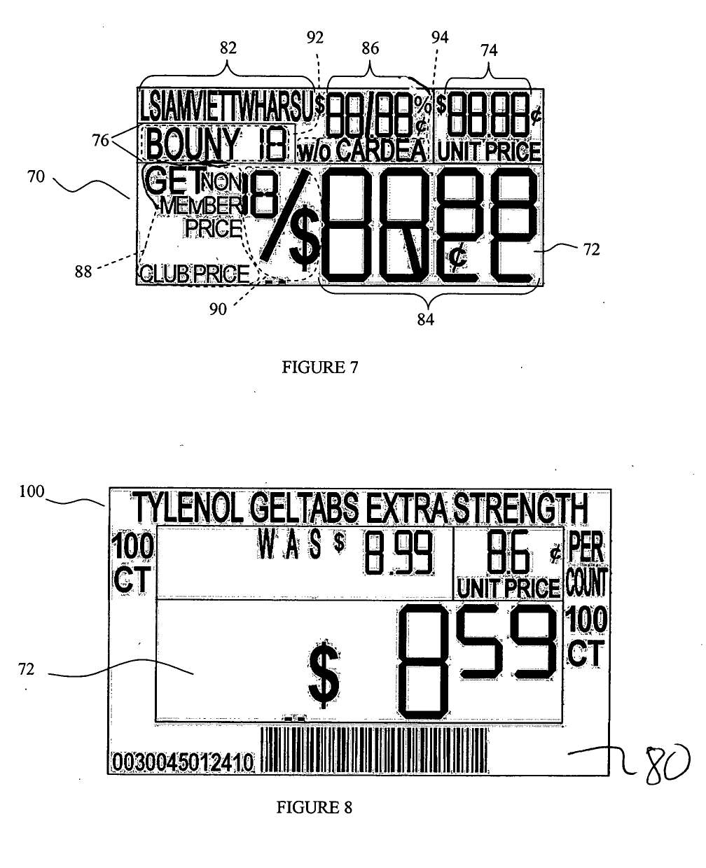

FIG. 7 shows a presently preferred layout for an LCD display 70 that can be used in an ESL. LCD display 70 contains an active area 72 having LCD segments fabricated thereon. The active area 72 has numerous regions, each of which allows different types of information to be displayed. Certain regions will use interleaved text while others will not. For example, an embodiment of an ESL can have a unit price region 74 on its active area 72′ Unit price region will preferably utilize segmented numerical characters. Interleaved characters are not needed for unit price region 74. The active region 72 can have boundary lines 76 fabricated thereon that can be activated to subdivide the ESL into discrete informational areas.

In a preferred ESL, the LCD display 70 is embedded in an ESL package 600 having a fixed paper overlay label 80 that includes certain content, as seen in FIGS. 8-13. The content typically placed on fixed label 80 is information that will not change often, such as the product name, as well as identifiers such as barcodes and the like.

As discussed above with respect to FIG. 1, a typical shelf label will display pricing information for a product that does not currently have any special offers pending. Thus, the prior art paper shelf label 10 seen in FIG. 1 simply provides pricing information such as the price for this particular item and the unit pricing for this item. An ESL 100 presenting information for the same product being offered by shelf label 10 of FIG. 1 can be seen in FIG. 8. As discussed, the item being offered by shelf label 10 does not have any special offers pending. Thus, it is not necessary to display any special offers on the ESL 100. ESL 100 need only display pricing information. To enable the display of pricing information, active area 72 of LCD display 70 has a pricing display region 84. Pricing display region 84 can comprise segmented displays, as is seen in FIG. 7. In the presently preferred embodiment, pricing display region 84 comprises a plurality of segmented displays.

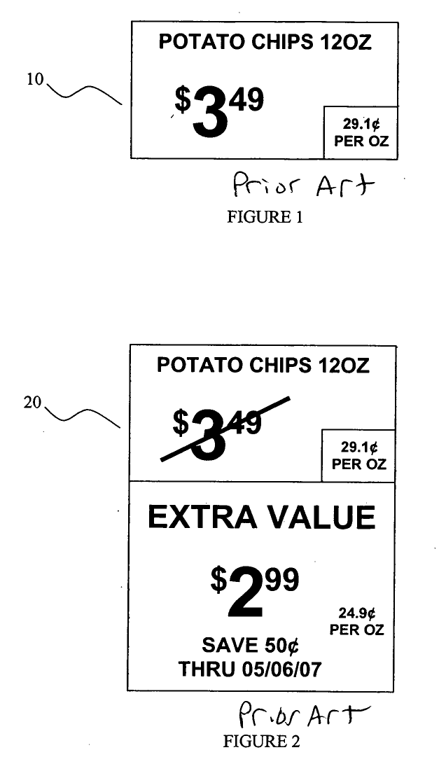

As discussed, exemplary paper shelf label 20 shown in FIG. 2 presents an Extra Value offer. Here an advantage of the embodiments of the ESL can be seen. Traditional paper shelf label 20 has information about the special offer printed thereon, for example the sale price. The traditional paper shelf label 20 also tells the customer the regular price for the item so the customer can see how much money they are saving. Of course, a retailer using this traditional paper shelf label 20 must have an employee find the shelf in the store where this item is located so they can affix this shelf label 20. In a store with thousands of items, this is a large task, as prices and special offers are constantly changing. By using an ESL, the retail can simply transmit the information to be displayed on the ESL, thereby eliminating the need for employees to find items and physically affix a shelf label. This provides a tremendous labor savings. In various preferred embodiments, data is transmitted to the ESL via radiofrequency signals, although other types of signals will work as well.

Instead of using information printed on a paper label, an ESL provides the consumer with information by selectively activating appropriate segments and characters on the active area 72 of LCD display 70. This can be seen in FIG. 8, where ESL 200 displays the Extra Value price. To provide this information, active area 72 preferably has a first interleaved character set region 82, which in the embodiment shown in FIG. 7 is as follows:

| | |
|---|---|
| LSIAMVIETTWHARSU | [All Available Characters] |

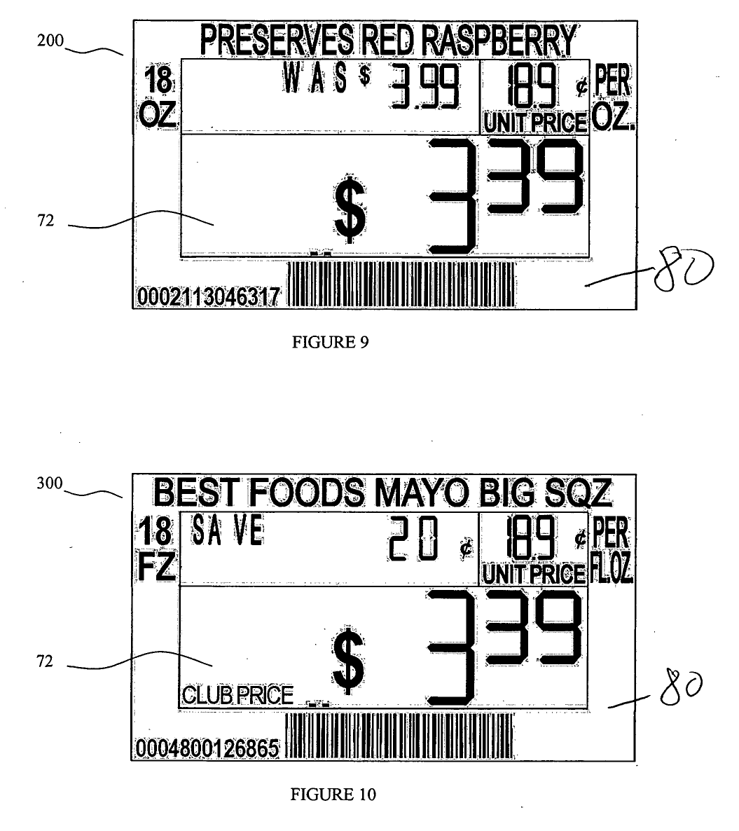

As is seen, first interleaved character set region 82 contains the characters “LSIAMVIETTWHARSU”. The driver circuitry of ESL 200 (not shown) selectively activates the characters forming first interleaved character set region 82 so that only those characters forming the word “WAS” are seen by the customer. As is seen in FIGS. 8 and 9, characters within the first interleaved character set region 82 are enabled as follows:

| | |
|---|---|
| LSIAMVIETTWHARSU | [Available Characters] |

| | |
|---|---|
| W A S | [Activated Characters] |

Likewise, active area 72 contains an interleaved segmented alphanumeric region 86. Interleaved segmented alphanumeric region 86 preferably comprises several segmented numerical characters as well as a “slash”, currency denomination indicators (for example a “$”, which is indicative of dollar based quantity, and a “¢”, which is indicative of a “cents” based quantity) a decimal point and a percent sign (“%”). In ESL 200 shown in FIG. 9, the segments of the first numerical region are selectively activated to display the prior regular price for the item, which in this case is “$3.99”. Thus, when the first interleaved character set region 82 and the first interleaved segmented alphanumeric region 86 are selectively activated as described, they show the message “WAS $3.99” to the consumer.

The price itself must also be shown on ESL 200. Thus, the active area 72 of LCD display 70 contains pricing display region 84. Pricing display region 84 preferably contains a plurality of display segments capable of displaying both numbers and, where necessary, certain letters. In a presently preferable embodiment, the pricing display region 84 also contains the character “¢”, which is indicative of “cents”. For ESL 200, as can be seen in FIG. 9, the interleaved pricing display region 84 indicates a price of “3³⁹”. Note that the segmented alphanumeric characters preferably used in pricing display region 84 can display numbers in various sizes.

In addition, active area 72 of LCD display 70 has a special character region 90 that can contain segmented numerical characters, as well as a slash “/” and a currency character (for example, a “$”). Special character region 90 is useful for many messages, as will be seen below. For ESL 200, special character region provides the “$” sign, so that ESL 200 displays a price of “$3³⁹”, for the item associated with this label.

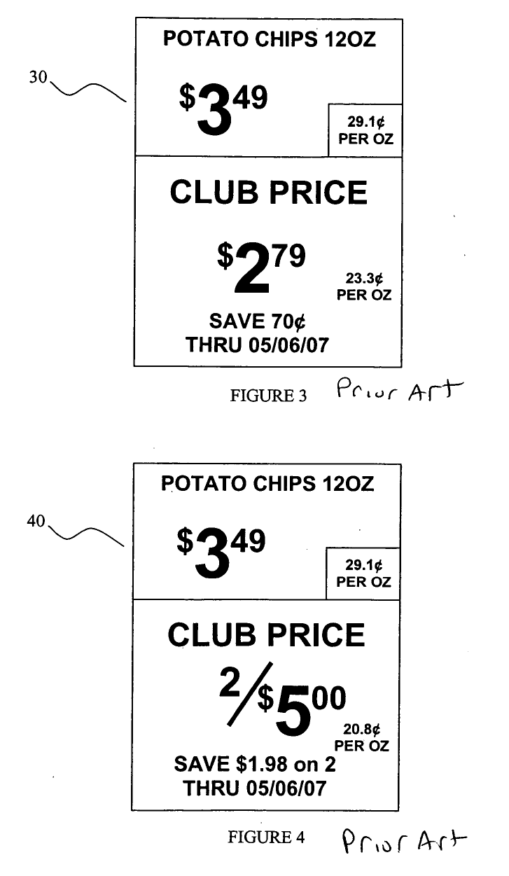

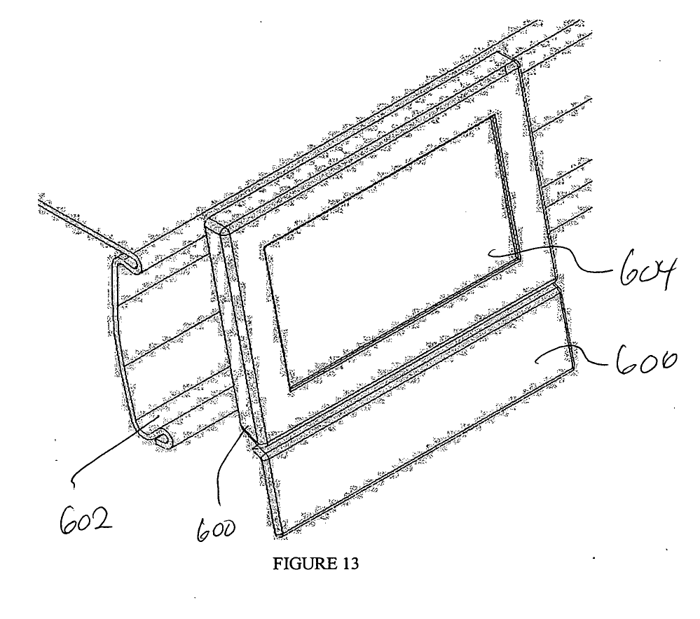

As discussed with reference to FIG. 3, many retailers have clubs entitling members of those clubs to reduced prices. Thus, in prior art paper shelf label 30, the customer is told that members of the retailer's loyalty club receive a reduced price. An ESL should be able to convey this information. The manner in which a presently preferred ESL conveys club prices to consumers can be seen with reference to FIG. 10. Thus, the active area 72 of the LCD display 70 preferably has a first special message region 88 that can convey such messages. One such message available in first special message region 88, which is seen in the example of ESL 300, states “CLUB PRICE”. Of course, depending upon the retailer, first special message region 88 can say anything for which there is space for. In this embodiment, first special message region 88 can also convey other information, such as “NON MEMBER PRICE” that could selected by having the customer press a button on the shelf label that would rewrite the active area 72 of LCD display 70 to display the non-member price. In addition or in the alternative, the ESL can be programmed to periodically display multiple frames of information that alternate between club and non-member prices. The present teachings are not particularly limited by the programming or display sequence used to convey the desired message to the end user; for example blinking some segments or inserting additional messages that may be alternately displayed are considered within the scope of the present teachings. First special message region 88 can have other messages embedded therein. As seen in FIG. 7, the word “GET” is also present in first special message region 88. The word “GET” will be described below with respect to FIG. 12.

In the present teachings, any display regions containing numeric fields (e.g. 74, 84, 86, 92 and 90) can have a variety of significant digits (e.g. 2 digits for the dollars portion of item price region 84) that can be customized for various retail environments. For example, higher average price retail goods might require a 3 digit dollar display. The present teachings are not particularly limited to the number of significant digits in each of the various numeric fields described herein.

In addition, by using the first interleaved character set region 82 and the interleaved segmented alphanumeric region 86, information about the special offer being made to members of the club can be conveyed. For example, characters within the first interleaved character set 82 can be enabled as follows:

| | |
|---|---|
| LSIAMVIETTWHARSU | [Available Characters] |
| S A V E | [Activated Characters] |

Similarly, characters in the interleaved segmented alphanumeric region 86 are enabled such that “20¢” is displayed in that region. Thus, ESL 300 has a message stating “Save 20¢” presented to customers. As discussed, the pricing display region 84, in conjunction with special character region 90, provides the price for club members, which in the case of ESL 300 is “$3³⁹”.

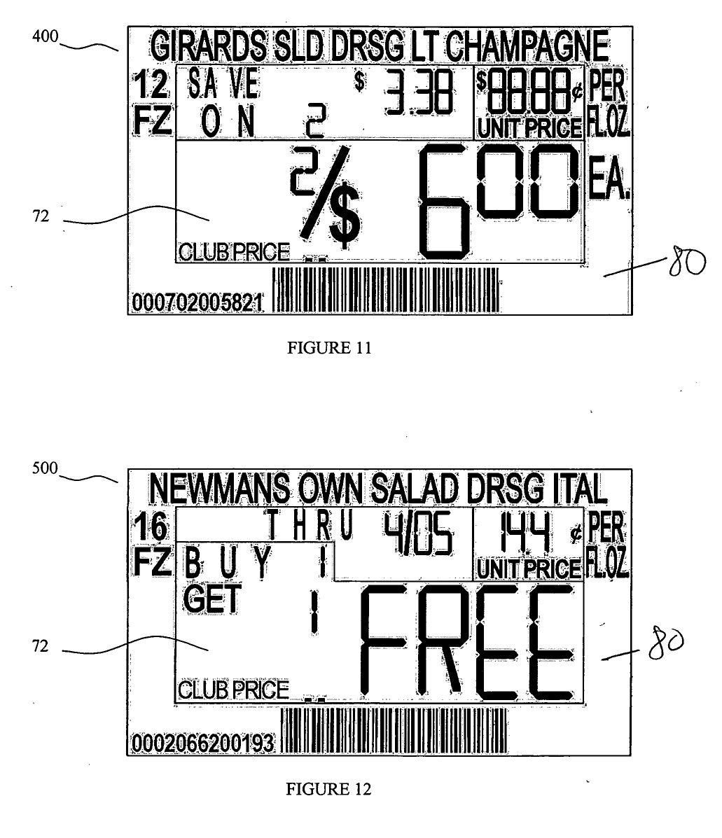

As discussed with reference to FIG. 4, retailers often have “two for $1” type sales. Paper shelf label 40, seen in FIG. 4, informs customers that an item located near this shelf label has a “two for $1” type special offer. ESLs should be able to convey this information, and the various ESL embodiments described herein can display such a message. FIG. 11 shows how a presently preferred embodiment can display a “two for $1” special offer. First, the characters within the first interleaved character set 82 can be enabled as follows:

| | |
|---|---|
| LSIAMVIETTWHARSU | [Available Characters] |
| S A V E | [Activated Characters] |

Thus, first interleaved character set 82 has its characters selectively enabled to display the word “SAVE”. Likewise, the characters in the interleaved segmented alphanumeric region 86 are enabled such that “$3.38” is displayed.

In a presently preferred ESL, the active area 72 of LCD display 70 has a second interleaved character set region 92. Second interleaved character set region 92 preferably comprises a series of interleaved characters, as well as segmented numerical characters. Additionally, the second interleaved character set 92 can be enabled as follows:

| | |
|---|---|
| BOUNY | [Available Characters] |
| O N | [Activated Characters] |

Thus the second interleaved character set 92 has its characters selectively enabled to display the word “ON”. Likewise the numeric characters in region 92 can be activated to display the number 2. Thus, ESL 300 has a message stating “SAVE $3.38 ON 2” presented to customers.

In addition, active area 72 on LCD display comprises a special character region 90 containing segmented numerical characters, as well as a slash “/” and a currency character (for example, a “$”). The segmented numerical characters of special character region 90 can indicate how may items the customer will receive for the price indicated in pricing display region 84. In ESL 400, a segmented numerical character present in special character region 90 displays a “2”. The slash (“/”) in special character region is also activated, as is the dollar sign (“$”). In addition, pricing display region 84 provides the price of the item. Thus, as is seen in FIG. 11, ESL 400 displays the message “2/$6⁰⁰” to the customer.

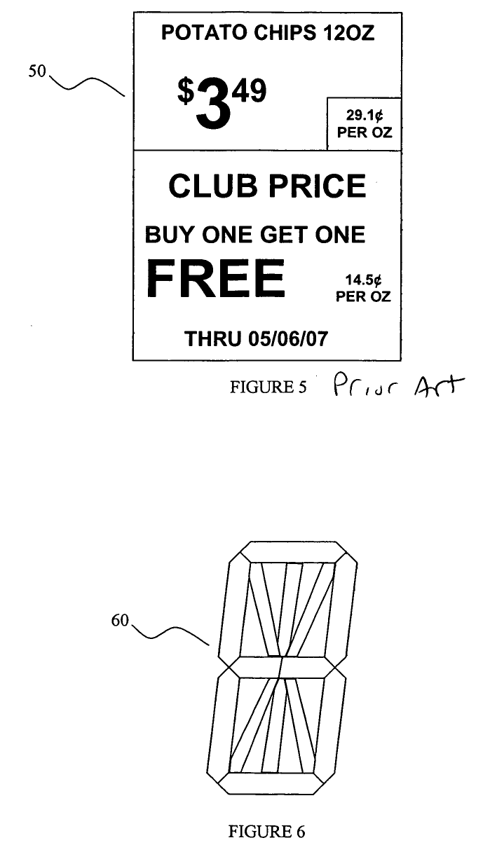

Another type of special offer is a “buy one, get one free” type offer. A prior art “buy one, get on free” paper shelf label 50 can be seen in FIG. 5. ESLs should have the ability to convey this information to the user. As is seen in FIG. 12, a presently preferred ESL 500 is shown conveying the “buy one, get one free” offer to the consumer. In the embodiment of ESL 500 seen in FIG. 12, the characters within the first interleaved character set 82 can be enabled as follows:

| | |
|---|---|
| LSIAMVIETTWHARSU | [Available Characters] |

| | |
|---|---|
| T H R U | [Activated Characters] |

Thus, the first interleaved character set 82 displays the word “THRU”. Interleaved segmented alphanumeric region 86 has segments activated such that the date upon which the special offer ends is displayed. In the example shown in FIG. 12, segments are activated such that “4/12” is displayed. Thus, first interleaved character set region 82 in combination with the interleaved segmented alphanumeric region 86 provide the message “THRU 4/12”, which consumers will understand to mean that the special offer will end April 12.

In a presently preferred ESL, the active area 72 of LCD display 70 has a second interleaved character set region 92. Second interleaved character set region 92 preferably comprises a series of interleaved characters, as well as segmented numerical characters. In the “buy one, get one free” example, the second interleaved character set region can have its characters activated as follows:

| | |
|---|---|
| BOUNY | [Available Characters] |
| B U Y | [Activated Characters] |

Thus, in ESL 500, the second interleaved character set region 92 displays “BUY” to the customer. The segmented numerical characters within the second interleaved character set region 92 can be similarly selectively activated to display the number “1”. The “GET” found in the special message region 88 can also be activated. Likewise, one of the segmented numerical characters in special character region 90 can have selected segments activated to display a “1”. Finally, the pricing display region 84 can have selected segments activated such that it states “FREE”. Thus, the combination of second interleaved character set region 92, special message region 88, special character region 90 and pricing display region 84, in combination, state “BUY 1 GET 1 FREE”.

In one embodiment, the ESL 500 can cycle through more than one message. For example, the ESL 500 can have the display seen in FIG. 12 alternate with another message providing the price in the pricing display region 84. By cycling through these messages, customers will learn what the price for one item is, as well as learning that they will receive one of those items free.

Thus, as can be seen, the various regions have various arrangements of interleaved characters and segmented alphanumeric characters that allow for a highly flexible ESL for displaying messages to customers. The range of messages that can be displayed is quite broad. For example, as has been seen, the first interleaved character set 82 can display several different words:

| | |
|---|---|
| LSIAMVIETTWHARSU | [Available Characters] |

| | |
|---|---|
| W A S | [Activated Characters] |

| | |
|---|---|
| S A V E | [Activated Characters] |

| | |
|---|---|
| T H R U | [Activated Characters] |

| | |
|---|---|
| L I M I T | [Activated Characters] |

Note that there are no limitations on the arrangement of characters used for interleaved messages. For example, the characters used for the first interleaved character set 82 could be rearranged and yet still provide various messages depending upon which characters are selectively activated:

| | |
|---|---|
| SWAAVSELTIHMRIUT | [Available Characters] |
| S A V E | [Activated Characters] |
| W A S | [Activated Characters] |

| | |
|---|---|
| L I M I T | [Activated Characters] |
| T H R U | [Activated Characters] |

Likewise, as has been seen, second interleaved character set region 92 can display several messages:

| | |
|---|---|
| BOUNY | [Available Characters] |
| B U Y | [Activated Characters] |
| O N | [Activated Characters] |

By having segmented numeric characters, second interleaved character set region 92 can also provide quantities.

Active area 72 of LCD display 70 also contains a third interleaved character region set 94. In a preferred embodiment, the third interleaved character region set 94. Third interleaved character region 94 can display many different messages as well:

| | | |
|---|---|---|
| w/o | CARDEA | [Available Characters] |
| w/ | CARD | [Activated Characters] |
| w/o | CARD | [Activated Characters] |

| | |
|---|---|
| EA | [Activated Characters] |

LCD display 70 will typically be mounted into an enclosure 600 that is affixed to shelf channel 602. Active area 72 of LCD display 70 be visible through an aperture 604 in enclosure 600. Fixed label 80 will surround the active area 72. An optional hanging tag with a secondary message 606 can form a component of enclosure 600 and can either be a permanent part of enclosure 600 or can be removable. Enclosure 600 will also house the other components that comprise an ESL. For example, ESL 600 will require a battery, an antenna and electronic circuitry. The electronic circuitry includes (but is not limited to) driver circuitry for the LCD display 70, processing electronics for handling data transmitted to the ESL 600, as well as circuitry for transmitting and receiving data. Additional information regarding the electronics found in enclosure 600 can be found in U.S. patent application Ser. No. 11/155,125, filed on Jun. 16, 2005 entitled “Low Power Wireless Communication System And Protocol” and U.S. patent application Ser. No. 11/156,193, filed on Jun. 16, 2005 entitled “Pseudo Noise Coded Communication Systems”.

What is claimed is:

1. A display system comprising:
a housing containing an electronic display device, said electronic display device comprising an active area; and
a first interleaved character set region viewable on said active area comprising a first plurality of selectively activated characters, said plurality of selectively activated characters being interleaved such that a plurality of different messages can be displayed depending upon activation states of said plurality of selectively activated characters.

2. The display system of claim 1 wherein said first plurality of selectively activated characters of said first interleaved character set region comprises LSIAMVIETTWHARSU.

3. The display system of claim 1, further comprising an interleaved segmented alphanumeric region comprising a plurality of segmented numerical characters, a “/” a “.” and at least one symbol indicative of a currency denomination.

4. The display system of claim 3 wherein characters spelling “THRU” from said first plurality of selectively activated characters of said first interleaved character set region are selectively activated; and
wherein segments of said plurality of segmented numerical characters of said interleaved segmented alphanumeric region are selectively activated to display a date “xx/xx” where each “x” comprises an integer, thereby forming the message “THRU xx/xx”.

5. The display system of claim 3 wherein characters spelling “WAS” from said first plurality of selectively activated characters of said first interleaved character set region are selectively activated;
wherein segments of said plurality of segmented numerical characters of said interleaved segmented alphanumeric region are selectively activated to display a price “xx.xx” where each “x” comprises an integer, thereby forming the message “WAS xx.xx”.

6. The display system of claim 5 wherein said at least one symbol indicative of a currency denomination, “z”, of said interleaved segmented alphanumeric region is activated, thereby forming the message “WAS zxx.xx”.

7. The display system of claim 3 wherein said first interleaved character set region in combination with said interleaved segmented alphanumeric region can display “SAVE axx.xxz”, where each “x” comprises an integer formed by selectively activating segments of said plurality of segmented numerical characters and wherein “a” and “z” comprise said currency denomination symbol.

8. The display system of claim 7 wherein only one of said at least one currency denomination symbols is activated.

9. The display system of claim 1 further comprising a second interleaved character set region comprising a second plurality of selectively activated characters and at least one segmented numerical display, said second plurality selectively activated characters being interleaved such that a plurality of different messages can be displayed depending upon activation states of said plurality of selectively activated characters.

10. The display system of claim 9 wherein said second plurality of selectively activated characters of said second interleaved character set region comprises BOUNY.

11. The display system of claim 9 wherein said first interleaved character set region is located above said second interleaved character set region, thereby allowing said first interleaved character set region and said second interleaved character set region to display words that can be read as a message.

12. The display system of claim 11 wherein said first interleaved character set region can have said first plurality of selectively activated characters selectively activated to display “SAVE” and said second interleaved character set region can have said second plurality of selectively activated characters selectively activated to display “ON” and said at least one segmented numerical display having segments selectively activated to display a number, thereby forming a message stating “SAVE ON x”, where x is an integer comprised of at least one digit.

13. The display system of claim 1 further comprising a pricing display region, said pricing display region comprising a plurality of alphanumeric segmented characters, each of said plurality of alphanumeric segmented characters of said pricing display region comprising segments that can be selectively activated to display an alphanumeric character.

14. The display system of claim 13 wherein said pricing display region can have said segments of said plurality of alphanumeric segmented characters selectively activated to display a numeric price.

15. The display system of claim 13 wherein said pricing display region can have said segments of said plurality of alphanumeric segmented characters selectively activated to display a word.

16. The display system of claim 15 wherein said word is “FREE”.

17. The display system of claim 13, further comprising a first special message region, said first special message region comprising a plurality of selectively activated words.

18. The display system of claim 17 wherein said first special message region can have the word “get” selectively activated.

19. The display system of claim 18, further comprising a special character region, said special character region comprising selectively activated characters and at least one segmented numerical character.

20. The display system of claim 19 wherein at least one of said selectively activated characters located in said special character region is a symbol indicative of a currency denomination.

21. The display system of claim 19 wherein one of said selectively activated characters located in said special character region is a “/” and wherein said at least one segmented numerical character is comprised of segments that can be selectively activated to display a number.

22. The display system of claim 21 wherein said first special message region is located to the left of said special character region and said special character region is located to the left of said pricing display region.

23. The display system of claim 19, further comprising a second interleaved character set region comprising a plurality of selectively activated characters and at least one segmented numerical display, said selectively activated characters being interleaved such that a plurality of different messages can be displayed depending upon activation states of said plurality of selectively activated characters.

24. The display system of claim 23 wherein said second plurality of selectively activated characters of said second interleaved character set region comprises BOUNY.

25. The display system of claim 24 wherein said second interleaved character set region, said first special message region, said special character region and said pricing display region can have their characters and segments selectively activated to form messages stating “BUY x get y FREE”, where “x” and “y” are integers.

26. The display system of claim 25 wherein “x” and “y” can be the same integers.

27. The display system of claim 1 wherein said electronic display device comprises an LCD device having said first interleaved character set region fabricated thereon.

28. The display system of claim 27 wherein said LCD device is disposed in a package.

29. A display system comprising:
a housing containing an electronic display device comprising an active area;
a first interleaved character set region viewable on said active area comprising a first plurality of selectively activated characters, said first plurality of selectively activated characters being interleaved such that at least two different words can be displayed at different times depending upon activation states of said first plurality of selectively activated characters;
a second interleaved character set region within said active area arranged below said first interleaved character set and comprising a second plurality of selectively activated characters and a first segmented character, said second plurality of selectively activated characters being interleaved such that at least two different words can be displayed at different times depending upon activation states of said second plurality of selectively activated characters;
an interleaved segmented alphanumeric region comprising a plurality of second segmented characters, a “/” and a “.”, said interleaved segmented alphanumeric region located to the left of said first and second interleaved character set regions;
a first special message region, said first special message region comprising at least one selectively activated word, said first special message region arranged below said second interleaved character set region;
a special character region comprising a selectively activated slash (“/”) and a third segmented character, said special character region disposed below said second interleaved character set region and to the right of said first special message region;
a pricing display region comprising a plurality of fourth segmented characters, each of said plurality of fourth segmented characters comprising segments that can be selectively activated to display an alphanumeric character, wherein said pricing display region can have said segments of said plurality of fourth segmented characters selectively activated to display either a numeric price, a word or an alphanumeric message.

30. The display system of claim 29 wherein said first interleaved character set region can display the word “SAVE” by selectively activating appropriate characters interleaved within said first plurality of first selectively activated characters; and
said second interleaved character set region can display the word “ON” by selectively activating appropriate characters interleaved within said second plurality of first selectively activated characters, said second interleaved character set region selectively activating segments of said first segmented character to display a number “x” where “x” is an integer;
said interleaved segmented alphanumeric region selectively activating segments of said second segmented characters to display numbers “y”, where “y” is an integer and selectively activating the “.”; and
wherein the combination of said first interleaved character set region, said interleaved segmented alphanumeric region and said second interleaved character set region form a message stating “SAVE yy.yy ON x”.

31. The display system of claim 30 wherein.
said special character region selectively activates segments of said third segmented character to display a number “w” wherein “w” is an integer, said special character region selectively activates said “/”, wherein said “/” is adjacent and to the right of said third segmented display; and
said pricing display region selectively activates segments of said plurality of fourth segmented characters to display numerals “mmmm” indicative of a price, wherein m is an integer; and
wherein the combination of said first interleaved character set region, said interleaved segmented alphanumeric region, said second interleaved character set region, said special character region and said pricing display region form a message stating “SAVE yy.yy ON x w/MMMM” where “w/MMMM” appears below “SAVE yy.yy ON x”.

32. The display system of claim 29 wherein said second interleaved character set region can display the word “BUY” by selectively activating appropriate characters interleaved within said second plurality of selectively activated characters;
said second interleaved character set region selectively activates segments of said first segmented character to display a number “x” wherein “x” is an integer;
said first special message region having the word “GET” selectively activated;
said special character region selectively activates segments of said third segmented character to display a number “y” wherein “y” is an integer;
said pricing display region selectively activates segments of said plurality of fourth segmented characters to display the Word “FREE”; and
wherein the combination of said second interleaved character set region, said first special message region, said special character region and said pricing display region form a message stating “BUY x GET y FREE”.

33. The display system of claim 29 wherein said second interleaved character set region can display either the word “BUY” or the word “ON” depending upon which of said second plurality of selectively activated characters are activated.

34. The display system of claim 33 wherein said second plurality of selectively activated characters are arranged as “BOUNY”.

35. A display system comprising:
a housing containing an electronic display device having an active area; and
a plurality of selectively activated interleaved characters viewable from said active area, said plurality of selectively activated interleaved characters being interleaved such that at least two different messages can be displayed at different times depending upon activation states of each of said plurality of selectively activated interleaved characters.

36. The display system of claim 35 wherein said at least two different messages can comprise a single word.

37. The display system of claim 35 wherein each of said plurality of selectively activated interleaved characters are arranged such that regardless of what words are displayed at any one time, no adjacent characters of said plurality of selectively activated interleaved characters are activated at any one time.
